(19) United States
(12) Patent Application Publication
(10) Pub. No.: US 2008/0028573 A1
(43) Pub. Date: Feb. 7, 2008

(54) Hinge device and scanning apparatus using the same

(75) Inventors: Shen-Chung Tsai, Niaosong Township (TW); Chi-Yao Chen, Nanjhuang Township (TW)

Correspondence Address: BIRCH STEWART KOLASCH & BIRCH, PO BOX 747, FALLS CHURCH, VA, 22040-0747, US

(73) Assignee: AVISION INC.

(21) Appl. No.: 11/882,437

(22) Filed: Aug. 1, 2007

(30) Foreign Application Priority Data
Aug. 3, 2006 (TW) 095128422

(51) Int. Cl. E05D 7/04; H04N 1/00

(52) U.S. Cl. 16/245; 16/242; 358/401

(57) ABSTRACT

A hinge device includes a first body, a second body and an adjustment assembly. The second body is mounted on a base and pivotally connected to the first body. The adjustment assembly, disposed on the base and contacting one of the first body and the second body, is for adjusting a position of the second body relative to the base. A scanning apparatus using the hinge device is also disclosed.

### BACKGROUND OF THE INVENTION

1. Field of Invention

The invention relates to a hinge device and a scanning apparatus using the same, and more particularly to a hinge device which can be adjusted laterally, and a scanning apparatus using the same.

2. Related Art

Conventional scanners may be classified into a sheet-fed scanner, a flatbed scanner and a hybrid scanner having a sheet-fed scanning unit and a flatbed scanning unit. In the hybrid scanner, a scanning module for scanning a document and a sheet transporting module for transporting the document are respectively attached to a casing and a cover. The casing is pivotally connected to the cover through two hinge devices. Thus, the scanning module scans the document while the document is being fed by the sheet transporting module. Alternatively, the cover may also be opened so that the document, such as a book, can be placed on a scan platen of the casing and the scanning module can scan the document placed thereon.

Since the scanner ought to be able to accommodate a bound document, such as a book, the cover of the scanner is configured to be adjustable in height and the two hinge devices which are usually attached to the cover can be movably inserted into two slots of the casing.

In this case, when the hinge device and the cover are assembled improperly, a first scan window on the cover and a second scan window provided by the casing may be not in alignment with each other. Thus, the scanned document image obtained by the scanning module may be skew, thereby greatly influencing the scan quality.

### SUMMARY OF THE INVENTION

It is therefore an object of the invention to provide a hinge device which can be adjusted laterally, and a scanning apparatus using the same so that a user can adjust a position of the hinge device and thus adjust the skew between a cover and a casing of the scanning apparatus.

To achieve the above-identified object, the invention provides a hinge device which can be adjusted laterally and is to be movably mounted on a base. The hinge device includes a first body, a second body and an adjustment assembly. The second body is mounted on a base and pivotally connected to the first body. The adjustment assembly, disposed on the base and contacting one of the first body and the second body, is for adjusting a position of the second body relative to the base.

In addition, the invention also provides a scanning apparatus including a casing, a cover, a sheet transporting module and two hinge devices. The sheet transporting module is mounted on the cover and is for transporting a document while a scanning module in the casing acquires an image of the document. The two hinge devices connect the casing to the cover. At least one of the hinge devices includes a first body, a second body and an adjustment assembly. The second body is mounted on the cover and pivotally connected to the first body. The adjustment assembly, disposed on the cover and contacting one of the first body and the second body, is for adjusting a position of the second body relative to the cover.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic front view showing a scanning apparatus according to the invention;

FIG. 2 is a schematic bottom view showing a cover of the scanning apparatus according to the invention;

FIG. 3 is a first schematic top view showing the cover of the scanning apparatus of the invention;

FIG. 4 is a second schematic top view showing the cover of the scanning apparatus of the invention;

FIG. 5 is a first schematically partial side view showing a hinge device according to a first embodiment of the invention;

FIG. 6 is a second schematically partial side view showing the hinge device according to the first embodiment of the invention;

FIG. 7 is a schematic illustration showing the hinge device according to a modification of the first embodiment of the invention;

FIG. 8 is a schematic illustration showing the hinge device according to another modification of the first embodiment of the invention;

FIG. 9 is a first partially pictorial view showing a hinge device according to a second embodiment of the invention; and

FIG. 10 is a second partially pictorial view showing the hinge device according to the second embodiment of the invention.

### DETAILED DESCRIPTION OF THE INVENTION

The present invention will be apparent from the following detailed description, which proceeds with reference to the accompanying drawings, wherein the same references relate to the same elements.

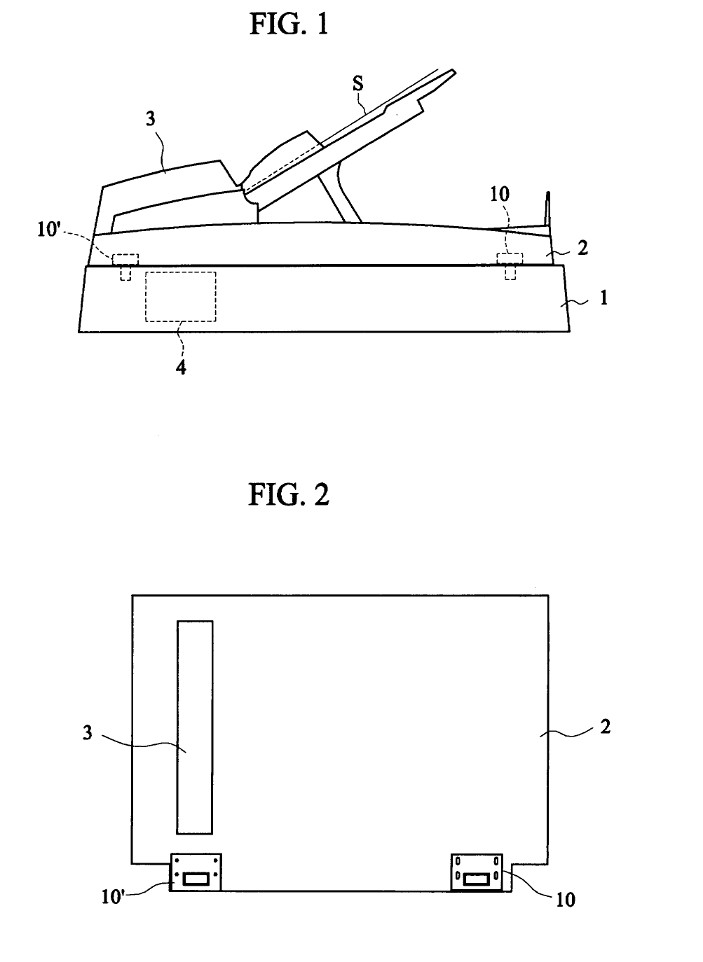

FIG. 1 is a schematic front view showing a scanning apparatus according to the invention. Referring to FIG. 1, the scanning apparatus of the invention includes a casing 1, a cover 2, a sheet transporting module 3 and two hinge devices 10 and 10′. The sheet transporting module 3 is mounted on the cover 2 and is for transporting a document S while a scanning module 4 in the casing 1 acquires an image of the document S. The hinge devices 10 and 10′ connect the casing 1 to the cover 2 so that the casing 1 is pivotally connected to the cover 2.

FIG. 2 is a schematic bottom view showing a cover of the scanning apparatus according to the invention. As shown in FIG. 2, the two hinge devices 10 and 10′ are disposed on the cover 2, and a sheet-fed scan window provided by the sheet transporting module 3 can be seen in the drawing. In this embodiment, the hinge device 10 can be adjusted laterally, but the hinge device 10′ cannot be adjusted laterally. However, the invention is not particularly restricted thereto. Both of the hinge devices 10 and 10′ may be adjusted laterally. In this case, not only the skew but also the offset between the cover 2 and the casing 1 can be adjusted.

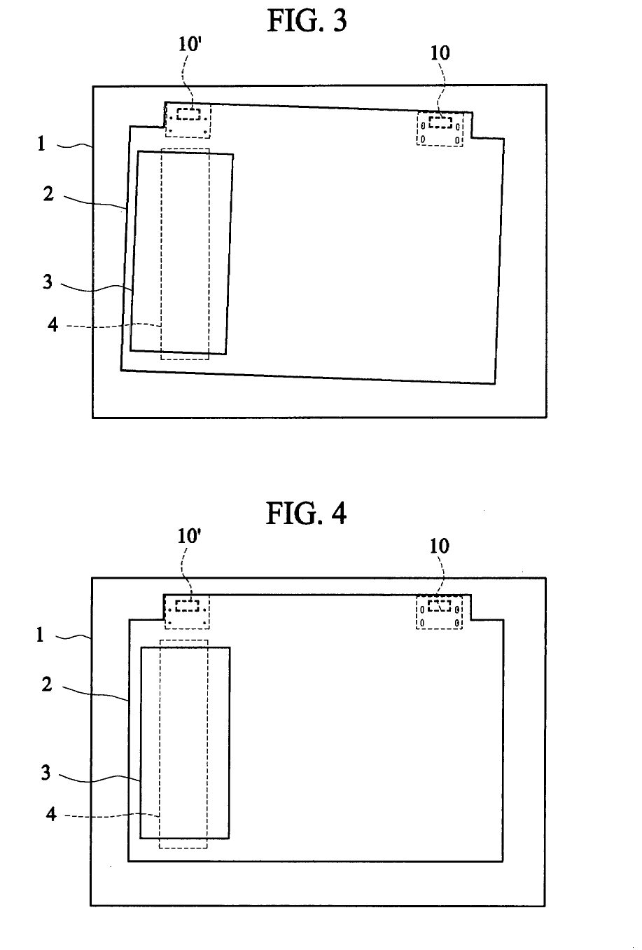

FIGS. 3 and 4 are schematic top views showing the cover of the scanning apparatus of the invention. As shown in FIG. 3, when the assembling error occurs, the cover 2 becomes oblique in position relative to the casing 1. In this case, the scanning module 4 is not parallel with the sheet transporting module 3 so that the image obtained by scanning the document has the skew. In this condition, the user may adjust the hinge device 10 such that the cover 2 and the casing 1 are in the state shown in FIG. 4. Thus, the image obtained by scanning the document is free from the skew.

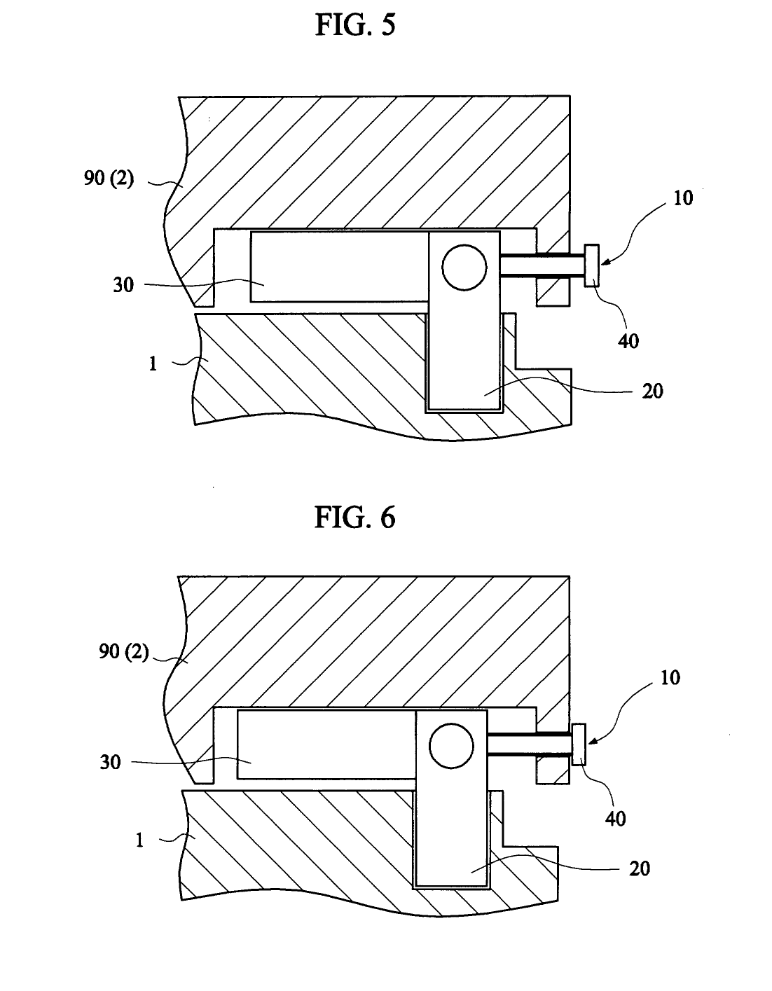

FIGS. 5 and 6 are schematically partial side views showing a hinge device according to a first embodiment of the invention. As shown in FIGS. 5 and 6, the hinge device 10 includes a first body 20, a second body 30 and an adjustment assembly 40. The second body 30 is mounted on the cover 2 or a base 90 and pivotally connected to the first body 20. The base 90 corresponds to one portion of the cover 2. The adjustment assembly 40 is disposed on the cover 2 or base 90 and contacts one of the first body 20 and the second body 30. In this embodiment, the adjustment assembly 40 contacts the second body 30 and is for adjusting a position of the second body 30 relative to the cover 2 or base 90. Adjusting the adjustment assembly 40 can make the second body 30 slide relative to the base 90 so that the skew of the document S relative to the scanning module 4 can be adjusted. In this embodiment, the adjustment assembly 40 is an adjustment screw.

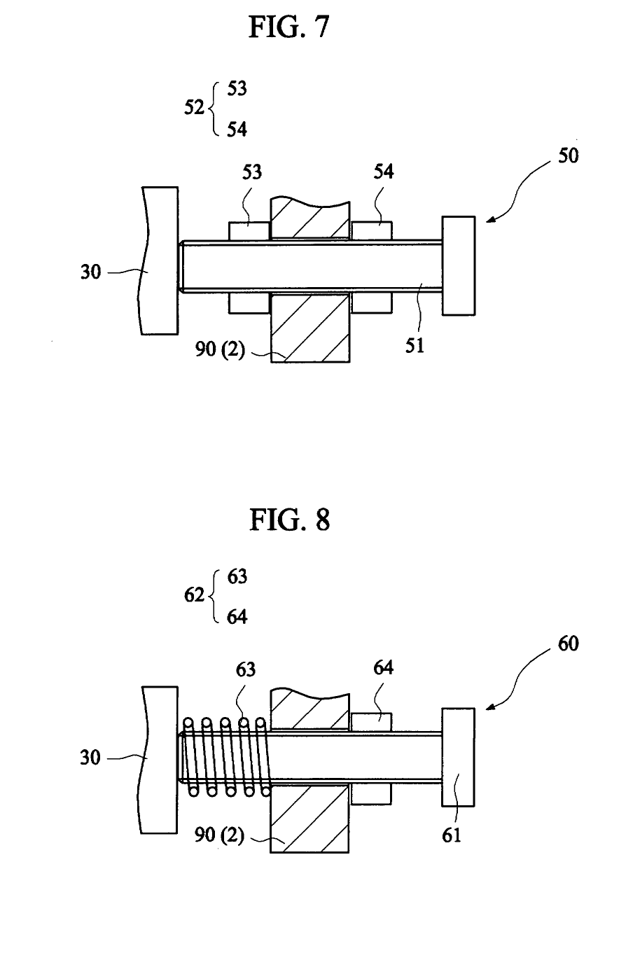

FIGS. 7 and 8 are schematic illustrations showing the hinge device according to a modification of the first embodiment of the invention. Referring to FIG. 7, an adjustment assembly 50 includes an adjustment screw 51 and a locking unit 52, which may engage the adjustment screw 51 for fastening the adjustment screw 51. In this example, the locking unit 52 includes two nuts 53 and 54, which are fit with the adjustment screw 51, located on two sides of the base 90 and may contact the base 90. The nuts 53 and 54 do not have to be provided simultaneously. Thus, the locking unit 52 may include only the nut 53 or 54, which is fit with the adjustment screw 51 and located on one side of the base 90.

As shown in FIG. 8, an locking unit 62 includes a nut 64 and a spring 63 fit with an adjustment screw 61, wherein the nut 64 and the spring 63 are respectively disposed on two sides of the base 90. The nut 64 contacts the base 90, while the spring 63 contacts the base 90 and the second body 30.

In the embodiment of FIGS. 7 and 8, the user has to unlock the locking unit 52 or 62 before the adjustment screw 50 or 60 is adjusted, and then lock the locking unit 52 or 62 after the adjustment is done. Thus, it is possible to prevent the adjustment screw from being loosened when the adjustment screw is in use.

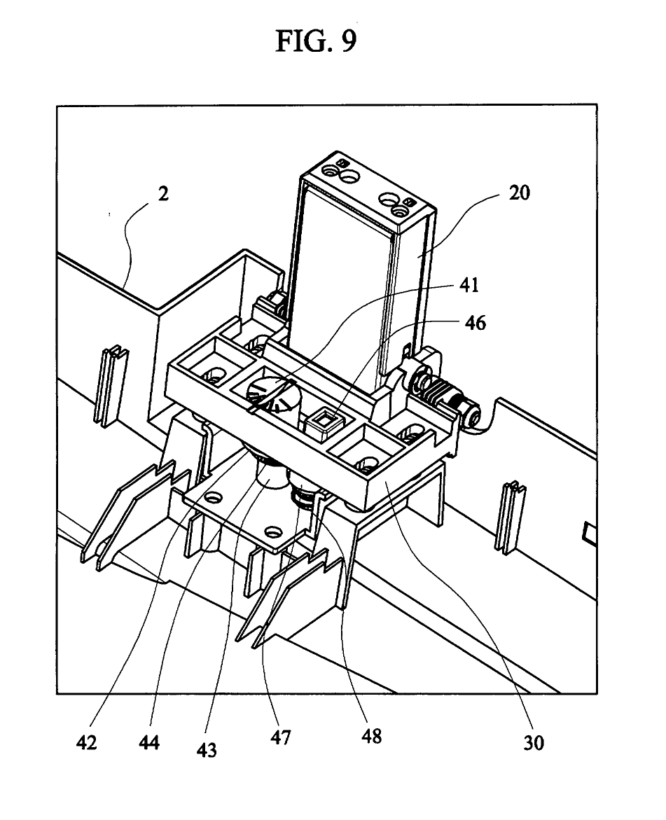

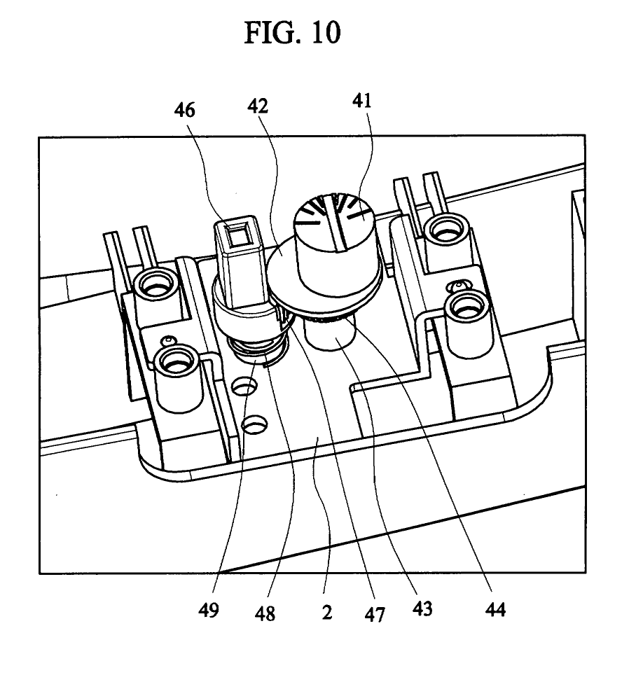

FIGS. 9 and 10 are partially pictorial views showing a hinge device according to a second embodiment of the invention. Referring to FIGS. 9 and 10, the adjustment assembly 40 of the hinge device 10 includes an adjustment cam 42, an adjustment gear 44 and a locking unit 46. A knob 41 is mounted on the adjustment cam 42, and the user can rotate the knob 41 and thus rotate the adjustment cam 42. The adjustment cam 42 is rotatably mounted on the base 90 and in contact with the second body 30. In this embodiment, the second body 30 is a frame portion. The adjustment gear 44 is fixed on the adjustment cam 42 and is rotatably mounted on an adjustment pin 43. The locking unit 46 is disposed adjacent to the adjustment gear 44. The locking unit may interlock with the adjustment gear 44 to prevent the adjustment cam 42 from rotating, and the locking unit may disengage from the adjustment gear 44 to allow the adjustment cam 42 to rotate.

In this embodiment, the locking unit 46 includes a locking gear 47 and a spring 48. The locking gear 47 is mounted on a base pin 49 of the base 90 and is rotatable and movable. The spring 48 encloses the base pin 49 and contacts the locking gear 47 to apply a spring force in a first direction to the locking gear 47. Thus, the user can press down the locking gear 47 to separate the locking gear 47 from the adjustment gear 44, and then rotate the adjustment gear 44 by a hand, a screw driver or a coin. Thus, the locking gear 47 interlocks with the adjustment gear 44 to prevent the adjustment cam 42 from rotating, and the locking gear 47 is disengaged from the adjustment gear 44 by being pressed in a second direction opposite to the first direction.

The scanning apparatus equipped with the hinge device which can be adjusted laterally according to the invention has the following advantages. Since the relative position between the hinge device and the cover can be adjusted, the user can adjust the parallelism between the sheet transporting module of the cover and the scanning module and thus avoid the skewed image. This scanning apparatus may be a plain sheet-fed scanner or a combination of a flatbed scanner and an automatic document feeder. In addition, sheet transporting rollers in some sheet transporting modules may transport the sheet slantingly if being worn unevenly. In this case, one of the hinge devices may be adjusted to correct the skew without replacing the transporting rollers immediately.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A hinge device comprising:
a first body;
a second body, mounted on a base and pivotally connected to the first body; and
an adjustment assembly, disposed on the base and contacting one of the first body and the second body, for adjusting a position of the second body relative to the base.

2. The hinge device according to claim 1, wherein the adjustment assembly is an adjustment screw.

3. The hinge device according to claim 1, wherein the adjustment assembly comprises an adjustment screw and a locking unit, wherein the locking unit may engage the adjustment screw for fastening the adjustment screw.

4. The hinge device according to claim 3, wherein the locking unit comprises a nut fit with the adjustment screw.

5. The hinge device according to claim 3, wherein the locking unit comprises two nuts fit with the adjustment screw.

6. The hinge device according to claim 3, wherein the locking unit comprises a nut and a spring both fit with the adjustment screw.

7. The hinge device according to claim 1, wherein the adjustment assembly comprises:
an adjustment cam, which is rotatably mounted on the base and contacts the second body;
an adjustment gear fixed to the adjustment cam; and
a locking unit, disposed adjacent to the adjustment gear, wherein the locking unit may interlock with the adjustment gear to prevent the adjustment cam from rotating, and the locking unit may disengage from the adjustment gear to allow the adjustment cam to rotate.

8. The hinge device according to claim 7, wherein the locking unit comprises:
a locking gear, mounted on a base pin of the base and being rotatable and movable; and
a spring, which encloses the base pin and contacts the locking gear to apply a spring force in a first direction to the locking gear.

9. The hinge device according to claim 8, wherein the locking gear interlocks with the adjustment gear to prevent the adjustment cam from rotating, and the locking gear is disengaged from the adjustment gear by being pressed in a second direction opposite to the first direction.

10. A scanning apparatus, comprising:
a casing;
a cover;
a sheet transporting module, mounted on the cover, for transporting a document while a scanning module in the casing acquires an image of the document; and
two hinge devices connected the casing to the cover, wherein at least one of the hinge devices comprises:
a first body;
a second body, mounted on the cover and pivotally connected to the first body; and
an adjustment assembly, disposed on the cover and contacting one of the first body and the second body, for adjusting a position of the second body relative to the cover.

11. The scanning apparatus according to claim 10, wherein the adjustment assembly is an adjustment screw.

12. The scanning apparatus according to claim 10, wherein the adjustment assembly comprises an adjustment screw and a locking unit, wherein the locking unit may engage the adjustment screw for fastening the adjustment screw.

13. The scanning apparatus according to claim 12, wherein the locking unit comprises a nut fit with the adjustment screw.

14. The scanning apparatus according to claim 12, wherein the locking unit comprises two nuts fit with the adjustment screw.

15. The scanning apparatus according to claim 12, wherein the locking unit comprises a nut and a spring both fit with the adjustment screw.

16. The scanning apparatus according to claim 10, wherein the adjustment assembly comprises:
an adjustment cam, rotatably mounted on the cover and contacting the second body;
an adjustment gear fixed to the adjustment cam; and
a locking unit, disposed adjacent to the adjustment gear, wherein the locking unit may interlock with the adjustment gear to prevent the adjustment cam from rotating, and the locking unit may disengage from the adjustment gear to allow the adjustment cam to rotate.

17. The scanning apparatus according to claim 16, wherein the locking unit comprises:
a locking gear mounted on a base pin of the cover and being rotatable and movable; and
a spring, which encloses the base pin and contacts the locking gear to apply a spring force in a first direction to the locking gear.

18. The scanning apparatus according to claim 17, wherein the locking gear interlocks with the adjustment gear to prevent the adjustment cam from rotating, and the locking gear is disengaged from the adjustment gear by being pressed in a second direction opposite to the first direction.
